(19) United States
(12) Patent Application Publication
(10) Pub. No.: US 2004/0263816 A1
(43) Pub. Date: Dec. 30, 2004

(54) Lithographic apparatus and device manufacturing method

(75) Inventor: Marinus Johannes Maria Van Dam, Venlo (NL)

Correspondence Address: PILLSBURY WINTHROP, LLP, P.O. BOX 10500, MCLEAN, VA, 22102, US

(73) Assignee: ASML NETHERLANDS B.V., Veldhoven (NL)

(21) Appl. No.: 10/830,424

(22) Filed: Apr. 23, 2004

(30) Foreign Application Priority Data
May 12, 2003 (EP) 03076421.1

(51) Int. Cl. G03B 27/54

(52) U.S. Cl. 355/67; 355/53; 355/55

(57) ABSTRACT

A method and apparatus, in particular for microlithographic exposure, comprising a radiation system for providing a projection beam of radiation; a support structure for supporting a patterning device, the patterning device serving to pattern the projection beam according to a desired pattern; a substrate table for holding a substrate; and a projection system for projecting the patterned beam onto a target portion of the substrate. Embodiments of the invention divide the projection beam into regions and select which features on the mask will be illuminated by which regions of the projection beam.

### BACKGROUND OF THE INVENTION

This application claims priority from EP application no. 03076421.1 filed May 12, 2003, the contents of which is incorporated herein in its entirety.

1. Field of the Invention

The present invention relates generally to a lithographic apparatus and method for its use.

2. Description of the Related Art

The term “patterning device” as here employed should be broadly interpreted as referring to devices that can be used to endow an incoming radiation beam with a patterned cross-section, corresponding to a pattern that is to be created in a target portion of the substrate; the term “light valve” can also be used in this context. Generally, the pattern will correspond to a particular functional layer in a device being created in the target portion, such as an integrated circuit or other device (see below). Examples of such patterning devices include:

A mask. The concept of a mask is well known in lithography, and it includes mask types such as binary, alternating phase-shift, and attenuated phase-shift, as well as various hybrid mask types. Placement of such a mask in the radiation beam causes selective transmission (in the case of a transmissive mask) or reflection (in the case of a reflective mask) of the radiation being incident on the mask, according to the pattern on the mask. In the case of a mask, the support structure will generally be a mask table, which ensures that the mask can be held at a desired position in the incoming radiation beam, and that it can be moved relative to the beam if so desired;

A programmable mirror array. One example of such a device is a matrix-addressable surface having a viscoelastic control layer and a reflective surface. The basic principle behind such an apparatus is that (for example) addressed areas of the reflective surface reflect incident light as diffracted light, whereas unaddressed areas reflect incident light as undiffracted light. Using an appropriate filter, the undiffracted light can be filtered out of the reflected beam, leaving only the diffracted light behind; in this manner, the beam becomes patterned according to the addressing pattern of the matrix-addressable surface. An alternative embodiment of a programmable mirror array employs a matrix arrangement of tiny mirrors, each of which can be individually tilted about an axis by applying a suitable localized electric field, or by employing piezoelectric actuators. Again, the mirrors are matrix-addressable, such that addressed mirrors will reflect an incoming radiation beam in a different direction to unaddressed mirrors; in this manner, the reflected beam is patterned according to the addressing pattern of the matrix-addressable mirrors. The required matrix addressing can be performed using suitable electronic controllers. In both of the situations described above, the patterning device can comprise at least one programmable mirror array. More information on mirror arrays as here referred to can be gleaned, for example, from U.S. Pat. Nos. 5,296,891 and 5,523,193, and PCT patent applications WO 98/38597 and WO 98/33096, which are incorporated herein by reference. In the case of a programmable mirror array, the support structure may be embodied as a frame or table, for example, which may be fixed or movable as required; and

A programmable LCD array. An example of such a construction is given in U.S. Pat. No. 5,229,872, which is incorporated herein by reference. As above, the support structure in this case may be embodied as a frame or table, for example, which may be fixed or movable as required.

For purposes of simplicity, the rest of this text may, at certain locations, specifically direct itself to examples involving a mask and mask table; however, the general principles discussed in such instances should be seen in the broader context of the patterning device as set forth above.

Lithographic projection apparatus can be used, for example, in the manufacture of integrated circuits (ICs). In such a case, the patterning device may generate a circuit pattern corresponding to an individual layer of the IC, and this pattern can be imaged onto a target portion (e.g., comprising at least one dies) on a substrate (silicon wafer) that has been coated with a layer of radiation-sensitive material (resist). In general, a single wafer will contain a whole network of adjacent target portions that are successively irradiated via the projection system, one at a time. In current apparatus, employing patterning by a mask on a mask table, a distinction can be made between two different types of machine. In one type of lithographic projection apparatus, each target portion is irradiated by exposing the entire mask pattern onto the target portion at one; such an apparatus is commonly referred to as a wafer stepper or step-and-repeat apparatus. In an alternative apparatus, commonly referred to as a step-and-scan apparatus, each target portion is irradiated by progressively scanning the mask pattern under the projection beam in a given reference direction (the “scanning” direction) while synchronously scanning the substrate table parallel or anti-parallel to this direction; since, in general, the projection system will have a magnification factor M (generally <1), the speed V at which the substrate table is scanned will be a factor M times that at which the mask table is scanned. More information with regard to lithographic devices as here described can be gleaned, for example, from U.S. Pat. No. 6,046,792, incorporated herein by reference.

In a manufacturing process using a lithographic projection apparatus, a pattern (e.g., in a mask) is imaged onto a substrate that is at least partially covered by a layer of radiation-sensitive material (resist). Prior to this imaging step, the substrate may undergo various procedures, such as priming, resist coating and a soft bake. After exposure, the substrate may be subjected to other procedures, such as a post-exposure bake (PEB), development, a hard bake and measurement/inspection of the imaged features. This array of procedures is used as a basis to pattern an individual layer of a device, e.g., an IC. Such a patterned layer may then undergo various processes such as etching, ion-implantation (doping), metallization, oxidation, chemo-mechanical polishing, etc., all intended to finish off an individual layer. If several layers are required, then the whole procedure, or a variant thereof, will have to be repeated for each new layer. Eventually, an array of devices will be present on the substrate (wafer). These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing,” Third Edition, by Peter van Zant, McGraw Hill Publishing Co., 1997, ISBN 0-07-067250-4, incorporated herein by reference.

For the sake of simplicity, the projection system may hereinafter be referred to as the “lens;” however, this term should be broadly interpreted as encompassing various types of projection system, including refractive optics, reflective optics, and catadioptric systems, for example. The radiation system may also include components operating according to any of these design types for directing, shaping or controlling the projection beam of radiation, and such components may also be referred to below, collectively or singularly, as a “lens.” Further, the lithographic apparatus may be of a type having two or more substrate tables (and/or two or more mask tables). In such “multiple stage” devices the additional tables may be used in parallel, or preparatory steps may be carried out on at least one tables while at least one other tables are being used for exposures. Dual stage lithographic apparatus are described, for example, in U.S. Pat. No. 5,969,441 and WO 98/40791, both incorporated herein by reference.

In the semiconductor manufacturing industry there is increasing demand for ever-smaller features and increased density of features. In other words the critical dimension (CD) is rapidly decreasing and becoming very close to the theoretical resolution limit of state-of-the-art exposure tools such as step-and-repeat and step-and-scan apparatus as described above. Consequently, the requirements for the variations in the relative position (overlay) of exposed features also become critical.

Exposure tools typically comprise optical elements to manipulate the intensity and angular distribution of the projection beam being incident on the mask, creating regions of radiation with the required properties within the projection beam. Such regions may be substantially round (and called poles), but other shapes such as rings and bars are also possible. Different angular distributions are commonly called illumination modes, and they are selected to provide an optimal image on the substrate based upon the size and elongation direction (orientation) of features on the mask. However, a mask may typically comprise features of different sizes and orientations, which means that a single illumination mode may not provide the optimal exposure conditions for all features on the mask.

This problem is typically solved using a multiple-exposure technique, in which mask features are grouped into similar sizes and/or orientations, and each group of features is placed onto a separate mask. Each mask is then exposed in turn with a suitable illumination mode onto the same target portion on the substrate. Typically, this technique is restricted to two steps only, and is called double-exposure.

An example of double-exposure is shown in FIGS. 2A to 2D. A projection beam PB1, PB2 is shown in cross-section at a pupil plane in the illumination system, which is substantially perpendicular to optical axis A. Axes B and C define the pupil plane and are substantially perpendicular to each other and optical axis A. A mask MA1, MA2 being illuminated is substantially perpendicular to optical axis A, and thus substantially parallel to the pupil plane BC. Prior to performing the double-exposure, all mask features have been separated onto two masks based upon orientation, namely a first group of features 110 with an orientation substantially parallel to axis C on mask MA1; and a second group of features 210 with an orientation substantially parallel to axis B on mask MA2.

For imaging of the first group of features 110, it has been determined that illumination using a dipole of linearly-polarized light is most advantageous, in which the two poles which form the dipole are configured and arranged such that the axis joining its poles is substantially perpendicular to the elongation direction of the features 110, and in which the illumination light being incident upon the features is linearly polarized in a direction substantially parallel to the elongation direction of the features 110. Similarly, for imaging of the second group of features 210, it has been determined that illumination using a dipole of linearly-polarized light is most advantageous, in which two poles which form the dipole are configured and arranged such that the axis joining its poles is substantially perpendicular to the elongation direction of the features 210, and in which the illumination light being incident upon the features is linearly polarized in a direction substantially parallel to the elongation direction of the features 210.

Exposure then proceeds in two steps to ensure that each group of features is only exposed with the illumination mode that is most advantageous: in a first step, depicted in FIG. 2A, the first group of features 110 on mask MA1 is exposed using the projection beam PB1. The projection beam PB1 comprises a first region, namely a dipole of two poles 140 of linearly polarized light, disposed substantially symmetrically about optical axis A along axis B. The direction of polarization 145 of the light in the poles 140, and the elongation direction of the first group of features 110, are both substantially parallel to axis C. FIG. 2B shows a plan view of the first step viewed along optical axis A, illustrating the relative orientations of the poles 140, the direction of polarization 145, and the elongation direction of features 110 on the mask MA1.

In a second step, depicted in FIG. 2C, the second group of features 210 on mask MA2 is exposed using the projection beam PB2. The projection beam PB2 comprises a second region, namely a dipole of two poles 240 of linearly polarized light, disposed substantially symmetrically about optical axis A along axis C. The direction of polarization 245 of the light in the poles 240 and the elongation direction of the features 210 are substantially parallel to axis B. FIG. 2D shows a plan view of the second step viewed along optical axis A, illustrating the relative orientations of the poles 240, the direction of polarization 245, and the elongation direction of features 210 on the mask MA2.

If features 110 and 210 were disposed on the same mask (single-exposure), it would not be possible to image them with their own illumination modes—a compromise in illumination modes would have to be reached because light from both dipoles would be incident on each group of features. More details on double-exposure are given in European Patent Appl. No. EP 1,091,252, incorporated herein by reference.

In general, multiple-exposure is recognized to have three main disadvantages: an increase in cost due to extra masks that need to be designed and manufactured; a considerable decrease in throughput of the lithographic projection apparatus due to extra mask exchanges and extra exposures; and extra overlay errors that may be introduced between the images produced by each mask.

### SUMMARY OF THE INVENTION

Embodiments of the present invention provide a lithographic projection apparatus and methods that maintain the advantages of multiple exposure, but may not incur the associated throughput and overlay penalties.

This and other aspects are achieved according to embodiments of the invention by dividing the projection beam into parts, configuring the projection beam such that the parts of the projection beam correspond to regions in a pupil plane of the radiation system, and selecting which features on the mask will be illuminated by which regions of the projection beam. According to embodiments of the invention, there is provided a lithographic projection apparatus comprising: a radiation system for providing a projection beam of radiation; a support structure for supporting a patterning device, the patterning device serving to pattern the projection beam according to a desired pattern; a substrate table for holding a substrate; and a projection system for projecting the patterned beam onto a target portion of the substrate, wherein the radiation system is configured and arranged to provide the projection beam with a first part and a second part for cooperation with the patterning device providing a first patterning region and a second patterning region such that radiation in the second part of the projection beam is substantially prevented from being incident on the first patterning region of the patterning device.

According to a further aspect of the invention there is provided a device manufacturing method comprising providing a substrate that is at least partially covered by a layer of radiation-sensitive material; providing a projection beam of radiation using a radiation system, the projection beam comprising a first part and a second part; using a patterning device that substantially prevents radiation from the second part of the projection beam being incident upon a first patterning region of the patterning device; endowing the projection beam with a pattern in its cross-section; and projecting the patterned beam of radiation onto a target portion of the layer of radiation-sensitive material.

Although specific reference may be made in this text to the use of the apparatus according to the invention in the manufacture of ICs, it should be explicitly understood that such an apparatus has many other possible applications. For example, it may be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle,” “wafer” or “die” in this text should be considered as being replaced by the more general terms “mask,” “substrate” and “target portion,” respectively.

In the present document, the terms “radiation” and “beam” are used to encompass all types of electromagnetic radiation, including ultraviolet (UV) radiation (e.g., with a wavelength of 365, 248, 193, 157 or 126 nm) and extreme ultra-violet (EUV) radiation (e.g., having a wavelength in the range 5-20 nm).

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic projection apparatus according to an embodiment of the invention;

FIGS. 2A to 2D depict a prior art double-exposure sequence;

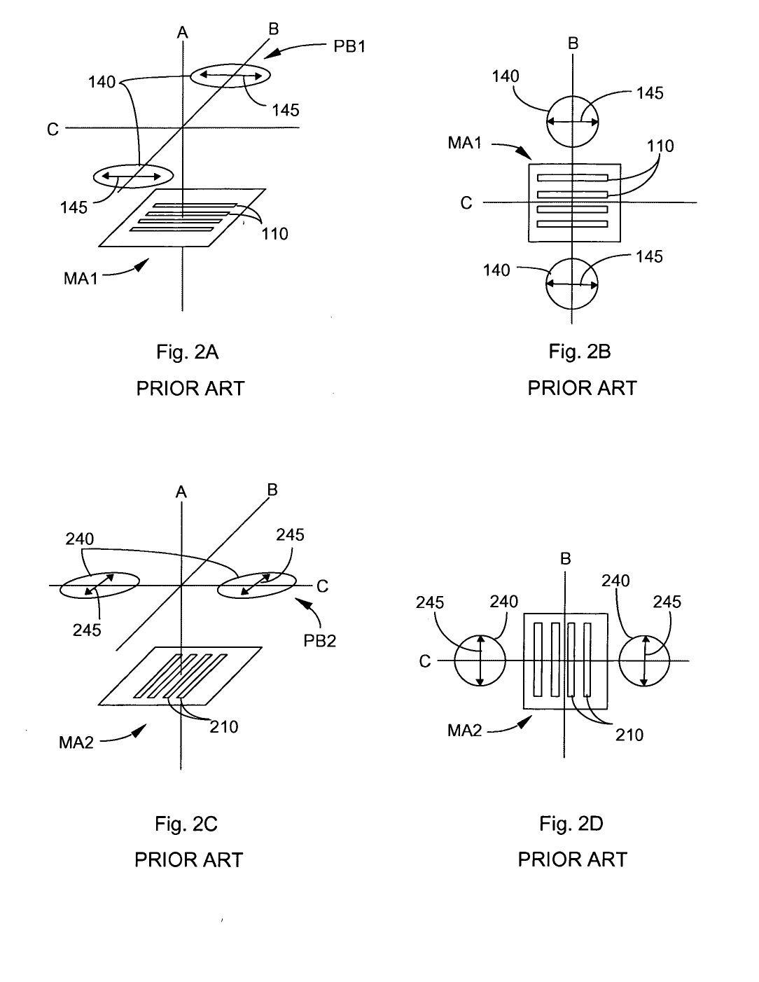

FIGS. 3A to 3B depict an illumination mode and mask configuration according to the invention;

FIGS. 4A to 4B depict another embodiment of an illumination mode and mask configuration;

FIGS. 5A to 5B depict yet another embodiment of an illumination mode and mask configuration;

FIGS. 6A to 6B depict still another embodiment of an illumination mode and mask configuration;

FIGS. 7A to 7B depict a further embodiment of an illumination mode and mask configuration;

FIGS. 8A to 8D depict examples of mask construction according to the invention; and

FIG. 9 depicts a device that may be used to create suitable illumination modes.

### DETAILED DESCRIPTION

### Embodiments

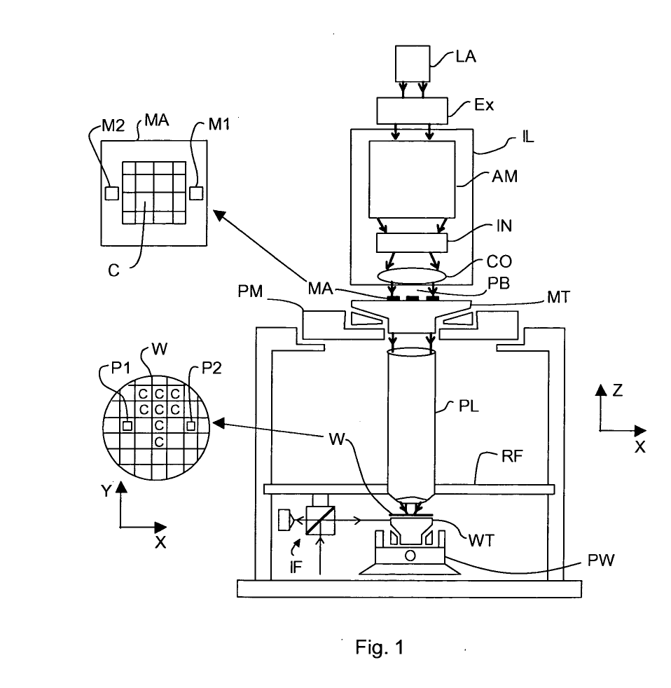

FIG. 1 schematically depicts a lithographic projection apparatus 1 according to a particular embodiment of the invention. The apparatus comprises:

a radiation system Ex, IL, for supplying a projection beam PB of radiation (e.g., DUV radiation). In this particular case, the radiation system also comprises a radiation source LA;

a first object table (mask table) MT provided with a mask holder for holding a mask MA (e.g., a reticle), and connected to first positioner PM for accurately positioning the mask with respect to item PL;

a second object table (substrate table) WT provided with a substrate holder for holding a substrate W (e.g., a resist-coated silicon wafer), and connected to second positioner PW for accurately positioning the substrate with respect to item PL; and

a projection system (“lens”) PL for imaging an irradiated portion of the mask MA onto a target portion C (e.g., comprising at least one die) of the substrate W.

As here depicted, the apparatus is of a transmissive type (i.e., has a transmissive mask). However, in general, it may also be of a reflective type, for example (with a reflective mask). Alternatively, the apparatus may employ another kind of patterning device, such as a programmable mirror array of a type as referred to above.

The source LA produces a beam of radiation. This beam is fed into an illumination system (illuminator) IL, either directly or after having traversed conditioning means, such as a beam expander Ex, for example. The illuminator IL may comprise adjustable elements AM for setting the outer and/or inner radial extent (commonly referred to as σ-outer and σ-inner, respectively) of the intensity distribution in the beam. In addition, it will generally comprise various other components, such as an integrator IN and a condenser CO. In this way, the beam PB being incident on the mask MA has a desired uniformity and intensity distribution in its cross-section.

It should be noted with regard to FIG. 1 that the source LA may be within the housing of the lithographic projection apparatus (as is often the case when the source LA is a mercury lamp, for example), but that it may also be remote from the lithographic projection apparatus, the radiation beam which it produces being led into the apparatus (e.g., with the aid of suitable directing mirrors); this latter scenario is often the case when the source LA is an excimer laser. The current invention and claims encompass both of these scenarios.

The beam PB subsequently intercepts the mask MA, which is held on a mask table MT. Having traversed the mask MA, the beam PB passes through the lens PL, which focuses the beam PB onto a target portion C of the substrate W. With the aid of the second positioner PW (and interferometer or linear encoder), the substrate table WT can be moved accurately, e.g., so as to position different target portions C in the path of the beam PB. Similarly, the first positioner PM can be used to accurately position the mask MA with respect to the path of the beam PB, e.g., after mechanical retrieval of the mask MA from a mask library, or during a scan. In general, movement of the object tables MT, WT will be realized with the aid of a long-stroke module (coarse positioning) and a short-stroke module (fine positioning), which are not explicitly depicted in FIG. 1. However, in the case of a wafer stepper (as opposed to a step-and-scan apparatus) the mask table MT may just be connected to a short stroke actuator, or may be fixed. Mask MA and substrate W may be aligned using mask alignment marks M1, M2 and substrate alignment marks P1, P2.

The depicted apparatus can be used in two different modes:

1. In step mode, the mask table MT is kept essentially stationary, and an entire mask image is projected at once (i.e., a single “flash”) onto a target portion C. The substrate table WT is then shifted in the x and/or y directions so that a different target portion C can be irradiated by the beam PB; and

2. In scan mode, essentially the same scenario applies, except that a given target portion C is not exposed in a single “flash.” Instead, the mask table MT is movable in a given direction (the so-called “scan direction,” e.g., the y direction) with a speed ν, so that the projection beam PB is caused to scan over a mask image; concurrently, the substrate table WT is simultaneously moved in the same or opposite direction at a speed V=Mν, in which M is the magnification of the lens PL (typically, M=¼ or ⅕). In this manner, a relatively large target portion C can be exposed, without having to compromise on resolution.

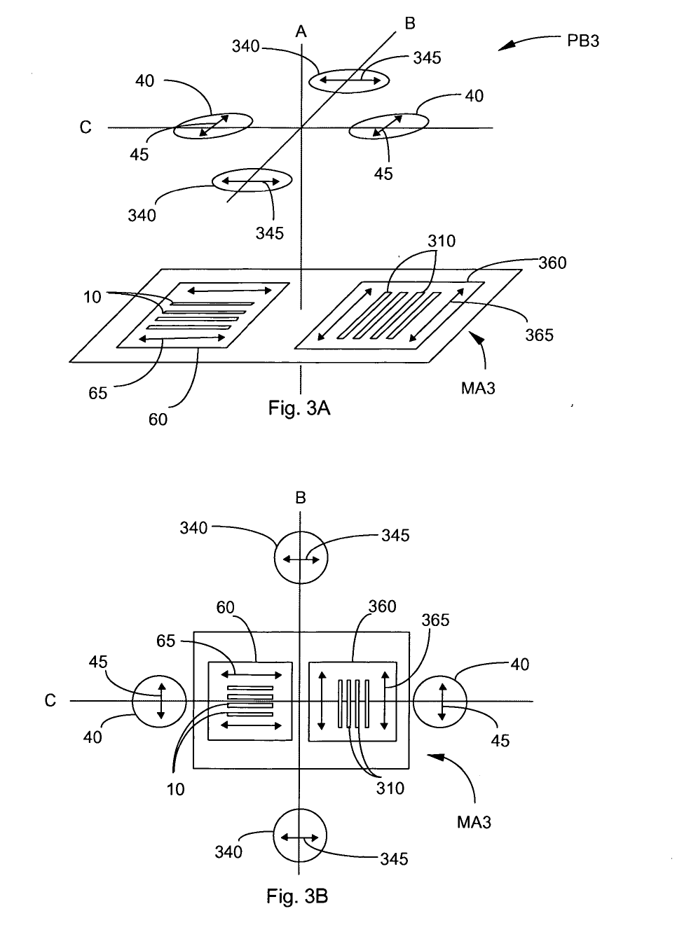

According to the invention, FIG. 3A shows a projection beam PB3 illuminating a mask MA3. The projection beam PB3 is shown in cross-section at a pupil plane in the illumination system, which is substantially perpendicular to optical axis A. Axes B and C define the pupil plane and are substantially perpendicular to each other and to optical axis A. The mask MA3 being illuminated is substantially perpendicular to optical axis A, and thus substantially parallel to the pupil plane BC.

For imaging of a first group of features 10 on the mask MA3, it has been determined that illumination using a dipole of linearly-polarized light is most advantageous, in which two poles which form the dipole are configured and arranged such that the axis joining its poles is substantially perpendicular to the elongation direction of the features 10, and in which the light being incident upon the features is linearly polarized in a direction substantially parallel to the elongation direction of the features 10. Similarly, for imaging of a second group of features 310 on the mask MA3, it has been determined that illumination using a dipole of linearly-polarized light is most advantageous, in which two poles which form the dipole are configured and arranged such that the axis joining its poles is substantially perpendicular to the elongation direction of the features 310, and in which the light being incident upon the group of features 310 is linearly polarized in a direction substantially parallel to the elongation direction of the features 310.

The mask MA3 comprises the first group of features 10 which have an elongation in a direction substantially parallel to axis C; the second group of features 310 which have an elongation in a direction substantially parallel to axis B; a first polarization filter 60 configured and arranged such that it only allows light to be incident upon the first group of features 10 with a polarization direction 65; a second polarization filter 360 configured and arranged such that it only allows light to be incident upon the second group of features 310 with a polarization direction 365. Direction 65 is substantially parallel to the elongation direction of the features 10, and direction 365 is substantially parallel to the elongation direction of the features 310.

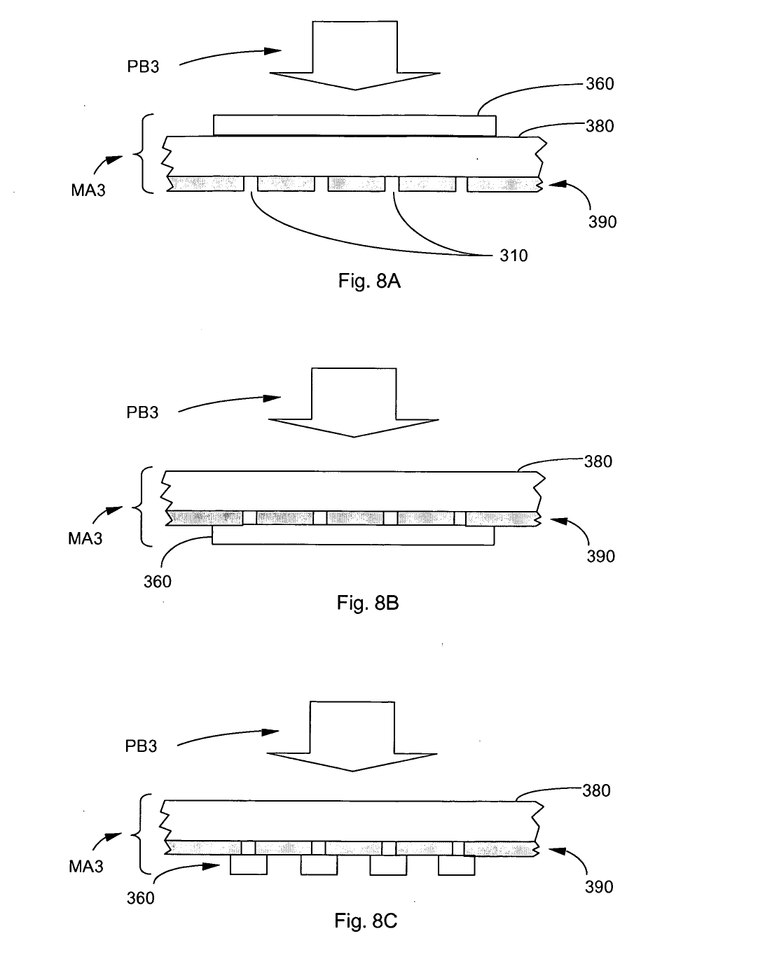

A cross-section through the mask MA3 in the region of the second group of features 310 is depicted in FIG. 8A—the mask MA3 comprises a substantially transparent substrate 380; a blocking layer 390, typically made of chrome, comprising areas which prevent transmission of the projection beam PB3; the second group of features 310 that transmit the projection beam PB3; and the polarization filter 360 (polarization layer). The second group of features 310 is actually formed by gaps between the areas of the blocking layer 390. In this configuration, the polarization filter 360 selects the radiation that can be incident upon the second group of features 310 based upon the polarization of the radiation. A suitable polarization filter 360 may be created, for instance, using lithographic processes such as deposition of a layer of polarizing or scattering material onto the substrate 380, and selectively etching the layer to create a filter 360 that only covers the second group of features 310. FIG. 8B shows an alternative construction in which a polarization filter 360 is created adjacent to the blocking layer 390—in this configuration, the polarization layer 360 selects the radiation that can be transmitted by the second group of features 310 based upon the polarization of the radiation. All references to layers that selects the radiation being incident upon features should be broadly interpreted as also covering the configuration where the layer selects the radiation being transmitted by such features. FIG. 8C shows a further variation in which a polarizing filter 360 only covers individual features from the second group 310, and which is shown in plan view along optical axis A in FIG. 8D. Although a mask of the binary type is depicted here, the same basic techniques can be used to create a polarizing layer on any type of mask, such as phase shift mask or reflective masks. Additionally, polarization filters can be created by forming suitable structures, such as gratings, on a surface of the mask.

As shown in FIG. 3A, the projection beam PB3 comprises a first region, namely a first dipole having poles 40 disposed substantially radially and symmetrically about the central optical axis A along axis C; and a second region, namely a second dipole having poles 340 disposed substantially radially and symmetrically about the central optical axis A along axis B. The linear polarization direction 45 of the radiation from the poles 40 is substantially parallel to the elongation direction of the features 310, and the polarization direction 345 of the radiation from the poles 340 is substantially parallel to the elongation direction of the features 10. Additionally, the poles 340 are configured to have substantially the same intensity of radiation as the poles 40.

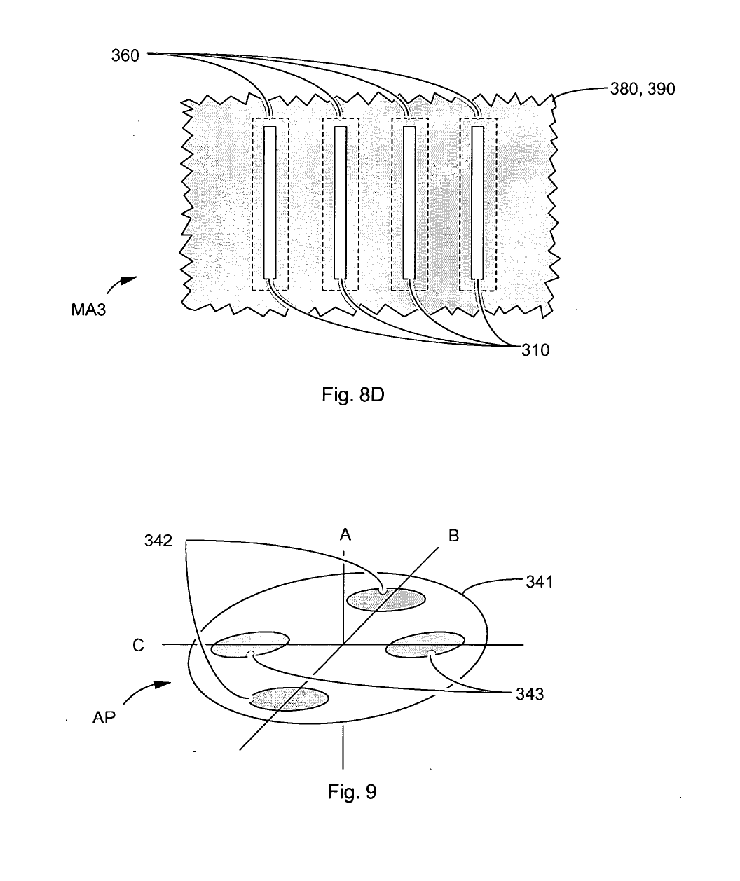

FIG. 9 shows how the required projection beam configuration may be created. An aperture AP comprises a first filtering region 341, configured and arranged to substantially block the illumination light; a second filtering region 342 comprised of two regions of linear-polarizing filter, configured and arranged to substantially transmit linearly-polarized light with a first polarization direction; and third filtering region 343 comprised of two regions of linear-polarizing filter, configured and arranged to substantially transmit linearly-polarized light with a second polarization direction. When the aperture AP is disposed substantially symmetrical about the optical axis A in a pupil plane of the illumination system, the second filtering region 342 creates the two poles 340 in the pupil plane BC and the third filtering region 343 creates two poles 40 in the pupil plane BC. Other combinations of illumination modes can be achieved by, for instance, adding additional filtering regions, changing the positions of the filtering regions or changing the shape of the filtering regions. Alternatively, the illumination modes can be created using diffractive optical elements (DOE's), polarization filters at the source or any combination of the methods shown.

FIG. 3B shows a plan view along optical axis A, where the relative orientations of the poles 40 and 340, the directions of polarization 45, 345, 65 and 365, and the elongation direction of features 10 and 310 on the mask MA3 are illustrated. During a single exposure, two groups of features are imaged using two illumination modes simultaneously without interference: the first group of features 10 are imaged using only radiation from the poles 340 of the first dipole, linearly-polarized in the elongation direction of the features 10; and the second group of features 310 are imaged using only radiation from the poles 40 of the second dipole, linearly-polarized in the direction elongation direction of the features 310.

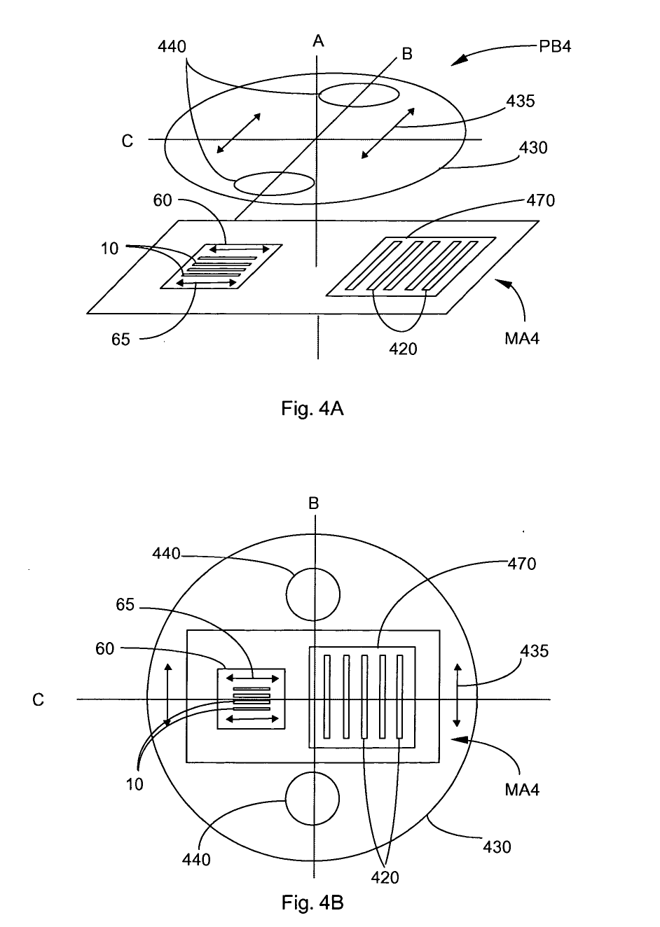

A second embodiment of the invention, which may be the same as the first embodiment save as described below, is shown in FIG. 4A. According to the invention, a projection beam PB4, depicted in cross-section at a pupil plane of the illumination system, illuminates a mask MA4. For imaging of a first group of features 10 on the mask MA4, it has been determined that illumination using a dipole of linearly-polarized light is most advantageous, which is configured and arranged such that the axis joining its poles is substantially perpendicular to the elongation direction of the features 10; and the light being incident upon the group of features 10 is linearly polarized in a direction substantially parallel to the elongation direction of the features 10. For imaging a second group of features 420 on the mask MA4, it has been determined that illumination using a single large pole 430 of randomly polarized light is most advantageous.

The mask MA4 comprises the first group of features 10 which have an elongation in a direction substantially parallel to axis C; the second group of features 420 which have a width that is substantially greater than the width of the features in the first group 10; a polarization filter 60 configured and arranged such that it only allows light with a polarization direction 65 to be incident upon the first group of features 10; and a neutral density filter 470 (gray filter) configured and arranged such that it reduces the amount of light being incident upon the second group of features 420. The polarization direction 65 is arranged to be substantially parallel to the elongation direction of the features 10. The neutral density filter 470 may be created and arranged in a similar way to that already indicated for the polarization filter.

The projection beam PB4 comprises a single pole 430, disposed substantially symmetrically about the central optical axis A, supplying light with a polarization direction 435 which is substantially perpendicular to the direction of polarization 65 that the filter 60 transmits; and a dipole having poles 440 supplying randomly polarized radiation. The poles 440 are disposed substantially symmetrical about optical axis A along axis B, and configured to have substantially the same intensity of radiation as the single pole 430.

FIG. 4B shows a plan view along optical axis A, where the relative orientations of the poles 430 and 440, the directions of polarization 435 and 65, and the elongation direction of features 10 on the mask are illustrated. During a single exposure, the mask MA4 is imaged using two illumination modes simultaneously without interference—the first group of features 10 is imaged using only part of the radiation from the dipole 440 that is transmitted through the filter 60; and the second group of features 420 is imaged using radiation from both the single pole 430 and the poles 440 of the dipole. Although both illumination modes 430, 440 are used to image the features 420, the radiation intensities are substantially equal and the second group of features 420 is effectively illuminated with a single large pole. The neutral density filter 470 reduces the light intensity being incident on the features 420, such that the exposure of the features 10 and 420 on the substrate can be performed simultaneously using the same dose.

For this embodiment, the intensity of the radiation from poles 440 that is incident on the first group of features 10 may be increased by employing radiation in the poles 440 which is preferentially linearly polarized in a direction substantially parallel to the polarization direction 65, and which is configured to produce the same intensity as the single pole 430.

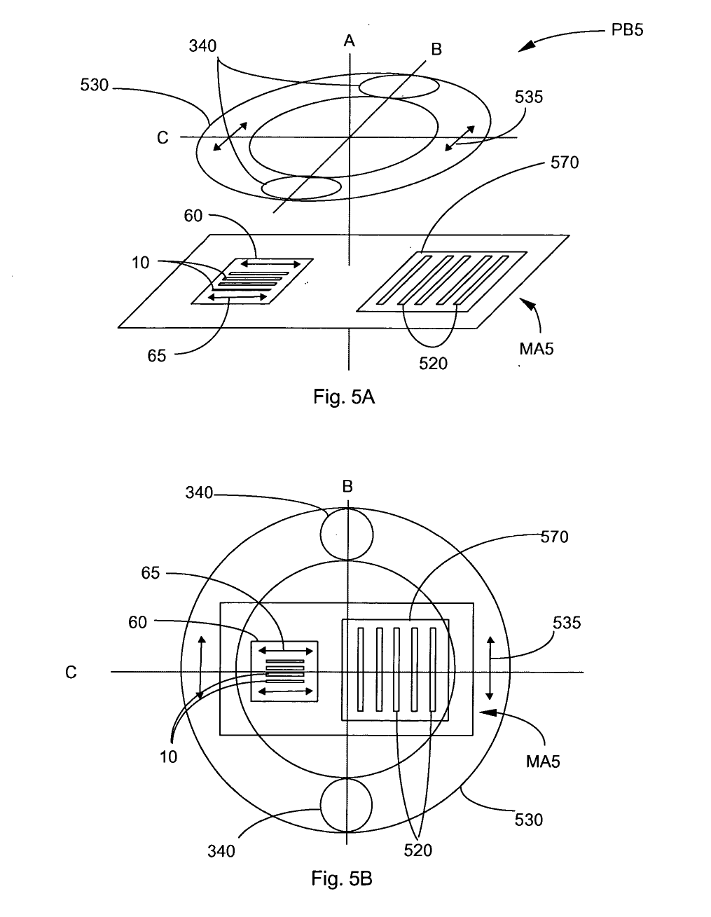

A third embodiment of the invention, which may be the same as the previous embodiments save as described below, is shown in FIG. 5A. According to the invention, a projection beam PBS, depicted in cross-section at a pupil plane of the illumination system, illuminates a mask MA5 which is disposed substantially perpendicular to optical axis A. For imaging of a first group of features 10 on the mask MA5, it has been determined that illumination using a dipole of linearly-polarized light is most advantageous, which is configured and arranged such that the axis joining its poles is substantially perpendicular to the elongation direction of the features 10; and the light being incident upon the features 10 is linearly polarized in a direction substantially parallel to the elongation direction of the features 10. For imaging of a second group of features 520 on the mask MA5, it has been determined that illumination using a single annular ring 530 of randomly polarized light is most advantageous.

The mask MA5 comprises the first group of features 10 which have an elongation in a direction substantially parallel to axis C; the second group of features 520 which have a width substantially greater than the width of features in the first group 10; a polarization filter 60 configured and arranged such that it only allows light with a polarization direction 65 to be incident upon the first group of features 10; a neutral density filter 570 arranged such that it reduces the amount of light being incident upon the second group of features 520. The polarization direction 65 is arranged to be substantially parallel to the elongation direction of the features 10.

The projection beam PB5 comprises an annular ring 530, disposed substantially symmetrically about the central optical axis A; and a dipole having poles 340 supplying randomly polarized radiation. The polarization direction 535 is substantially perpendicular to the direction of polarization 65 that the filter 60 transmits. The poles 340 are disposed substantially symmetrically about the optical axis A along axis B. Additionally, the poles 340 are configured to have substantially the same intensity of radiation as the annular ring 530.

FIG. 5B shows a plan view along optical axis A, where the relative orientations of the projection beam poles 340 and annular ring 530, the directions of polarization 535 and 65, and the elongation of features 10 on the mask are illustrated. During a single exposure, the mask MA5 is imaged using two illumination modes simultaneously without interference—the first group of features 10 is imaged using only part of the radiation from the poles 340 that is transmitted by the polarization filter 60; and the second group of features 520 is imaged using radiation from both the annular ring 530 and the poles 340. Although both illumination modes 340, 530 are used to image the features 520, the radiation intensities are substantially equal and the second group of features 520 is effectively illuminated with a single annular ring. The neutral density filter 570 reduces the light intensity being incident on the features 520, such that the exposure of the features 10 and 520 on the substrate can be performed simultaneously using the same dose.

For this embodiment, the intensity of the radiation from poles 340 being incident on the first group of features 10 may be increased by employing radiation in the poles 340 which is preferentially linearly polarized in a direction substantially parallel to the polarization direction 65, and which is configured to have the same intensity as the annular ring 530.

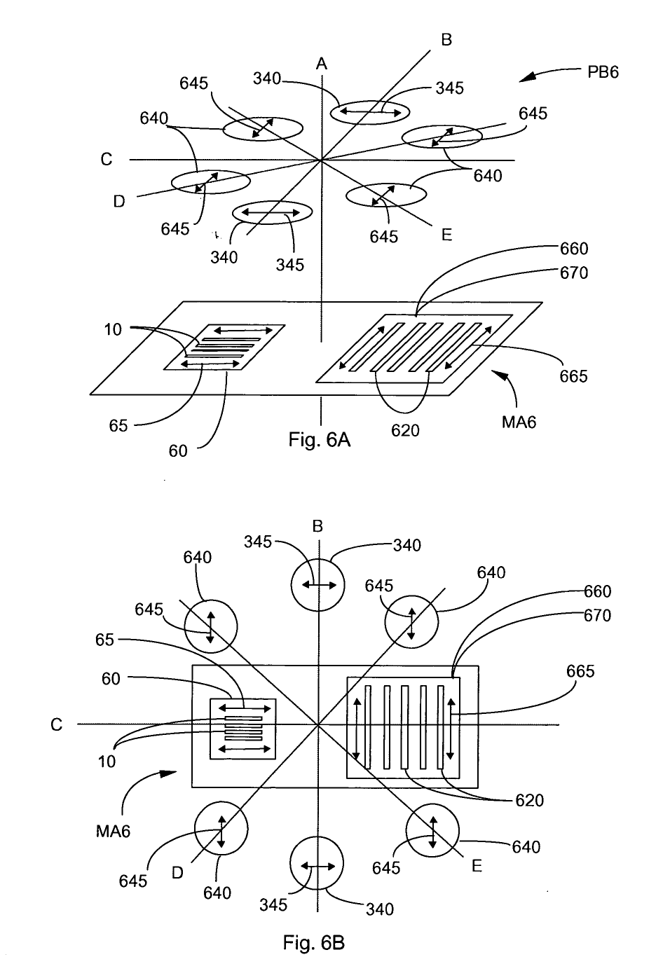

A fourth embodiment of the invention, which may be the same as the previous embodiments save as described below, is shown in FIG. 6A. According to the invention, a projection beam PB6, depicted in cross-section at a pupil plane of the illumination system, illuminates a mask MA6 which is disposed substantially perpendicular to optical axis A. Axes D and E are mutually perpendicular, and are disposed in the plane BC at an angle of substantially 45-degrees to the axes B and C.

For imaging of a first group of features 10 on the mask MA6, it has been determined that illumination using a dipole of linearly-polarized light is most advantageous, configured and arranged such that the axis joining its poles is substantially perpendicular to the elongation direction of the features 10; and when the light being incident upon the features 10 is linearly polarized in a direction substantially parallel to the elongation direction of the features 10. For imaging of a second group of features 620 on the mask MA6, it has been determined that illumination using two dipoles of linearly-polarized light, arranged substantially perpendicular to each other (quadrupole), is most advantageous. The dipoles are configured and arranged such that the axes joining their respective poles are mutually orthogonal, and each axis is substantially at an angle of 45 degrees to the elongation direction of the features 10. This latter mode is commonly referred to as quadrupole. When the poles of this quadrupole mode are rotated by 45 degrees, the resulting mode is commonly referred to as cross-quadrupole or c-quad.

The mask MA6 comprises the first group of features 10 which have an elongation in a direction substantially parallel to axis C; the second group of features 620 which have an elongation in a direction substantially parallel to axis B; a first polarization filter 60 configured and arranged such that it only allows light with a polarization direction 65 to be incident upon the first group of features 10; a second polarization filter 660 configured and arranged such that it only allows light with a polarization direction 665 to be incident upon the second group of features 620; and a neutral density filter 670 configured and arranged such that it reduces the amount of light being incident upon the second group of features 620. The features in the second group 620 have a width that is substantially greater than the width of the features in the first group 10. The polarization direction 65 is arranged to be substantially parallel to the elongation direction of the features 10, and similarly the polarization direction 665 is arranged to be substantially parallel to the elongation direction of the second group of features 620. In practice, it may be advantageous to combine the neutral density filter 670 and the second polarization filter 660 into a single filter layer.

The projection beam PB6 comprises a quadrupole having poles 640, disposed substantially symmetrically about the central optical axis A along axes D and E; and a dipole having poles 340, disposed substantially symmetrical about optical axis A along axis B. The radiation from the poles 640 has a polarization direction 645 that is substantially perpendicular to the direction of polarization 65 that the filter 60 transmits, and that is also substantially parallel to the direction of polarization 665 that the filter 660 transmits. The polarization direction 345 of the radiation from the poles 340 is substantially perpendicular to the polarization direction 345.

FIG. 6B shows a plan view along optical axis A, where the relative orientations of the poles 340 and 640, the directions of polarization 645, 345, 65 and 665, and the elongation direction of features 10 and 620 on the mask are illustrated. During a single exposure, the mask MA6 is imaged using two illumination modes simultaneously without interference—the first group of features 10 are imaged using only radiation from the poles 340, polarized in the elongation direction of the first group of features 10; and the second group of features 620 are imaged using only radiation from the poles 640, polarized in the elongation direction of the second group of features 620. The neutral density filter 670 reduces the light intensity being incident on the features 620, such that the exposure of the features 10 and 620 on the substrate can be performed simultaneously using the same dose.

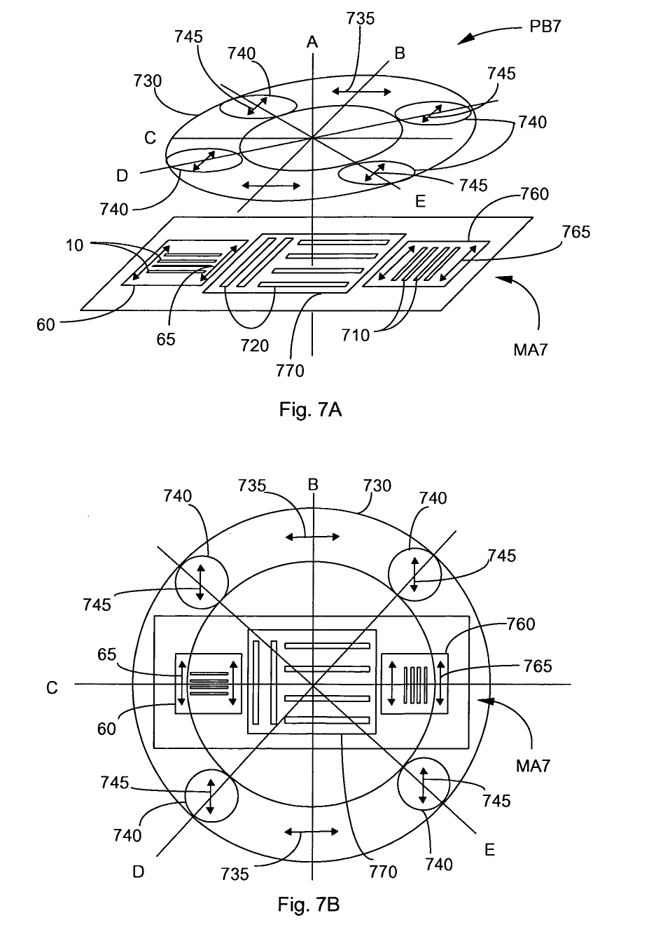

A fifth embodiment of the invention, which may be the same as the previous embodiments save as described below, is shown in FIG. 7A. According to the invention, a projection beam PB7, depicted in cross-section at a pupil plane of the illumination system, illuminates a mask MA7 which is disposed substantially perpendicular to optical axis A.

For imaging of a first group of features 10 on the mask MA7, it has been determined that illumination is most advantageous using a quadrupole, configured and arranged such that the axes joining the respective poles of each dipole are mutually orthogonal, and each axis of each dipole is substantially disposed at 45 degrees to the elongation direction of the features 10. For imaging of a second group of features 720 on the mask MA7, it has been determined that illumination using a single annular ring 730 is most advantageous. For imaging of a third group of features 710 on the mask MA7, it has been determined that illumination is most advantageous using a quadrupole, configured and arranged such that the axes joining the respective poles of each dipole are mutually orthogonal, and each axis of each dipole is substantially disposed at 45 degrees to the elongation direction of the features 710.

The mask MA7 comprises the first group of features 10 which have an elongation in a direction substantially parallel to axis C; the second group of features 720 which contains both features with an elongation direction substantially parallel to axis B, and features with an elongation direction substantially parallel to axis C; a third group of features 710 which have an elongation direction substantially parallel to axis B; a first polarization filter 60, configured and arranged such that it only allows light with a polarization direction 65 to be incident upon the first group of features 10; a second polarization filter 760 configured and arranged such that it only allows light with a polarization direction 765 to be incident upon the third group of features 710; and a neutral density filter 770 arranged such that it reduces the amount of light being incident upon the second group of features 720. Both the polarization directions 65 and 765 are arranged such that they are substantially parallel to the axis B.

The projection beam PB7 comprises a cross-quadrupole having four poles 740, disposed substantially symmetrically about the central optical axis A along axes D and E; and an annular ring 730, disposed substantially symmetrically about the central optical axis A. The polarization direction 735 is substantially perpendicular to both the directions of polarization 65 and 765 that the filters 60 and 760 respectively transmit. The polarization direction 745 is substantially parallel to both directions of polarization 65 and 765 that the filters 60 and 760 respectively transmit. Additionally, the poles 740 are configured to have substantially the same intensity of radiation as the annular ring 730.

FIG. 7B shows a plan view along optical axis A, where the relative orientations of the poles 740 and ring 730, the directions of polarization 745, 735, 65 and 765 are illustrated. During a single exposure, the mask MA7 is imaged using two illumination modes simultaneously without interference—the first group of features 10 and the third group of features 710 are imaged using only radiation from the poles 740; and the second group of features 720 are imaged radiation from both the poles 740 and the annular ring 730. Although both illumination modes 740, 730 are used to image the features 720, the radiation intensities are substantially equal and the second group of features 720 is effectively illuminated with a single annular ring. The neutral density filter 770 reduces the light intensity being incident on the features 720, such that the exposure of the features 10, 710 and 720 on the substrate can be performed simultaneously using the same dose.

Although the embodiments above describe the use of linearly polarized radiation only, the skilled artisan will appreciate that other types of polarization, such as circular and elliptical polarization, may be utilized in isolation or in combination to create a similar effect. Additionally, the embodiments describe the situation where polarization and neutral density layers are applied to groups of features. It may, however, be advantageous to apply these layers to intersecting features, or even apply them to parts of features such as the ends.

Applying a neutral density layer to a mask may also be employed to balance differences in doses due to the relative sizes of features, their relative proximity, or their density compared to other regions of the mask. For example, the light transmitted by relatively dense features may be reduced using a neutral density layer to balance the light transmitted by a relatively isolated feature.

Although the embodiments describe the use of the invention in an apparatus utilizing transmissive optics, it will be obvious to the skilled artisan that the same basic principles can be also employed in an apparatus utilizing reflective optics.

While specific embodiments of the invention have been described above, it will be appreciated that the invention may be practiced otherwise than as described. The description is not intended to limit the invention.

1. A lithographic apparatus comprising:
a support structure for supporting a patterning device, the patterning device serving to pattern a projection beam according to a desired pattern;
a substrate table for holding a substrate; and
a projection system for projecting the patterned beam onto a target portion of the substrate; and
an optical system configured and arranged to provide said projection beam with a first part and a second part for cooperation with the patterning device having a first patterning region and a second patterning region such that radiation in said second part of said projection beam is substantially prevented from being incident on said first patterning region of said patterning device.

2. A lithographic apparatus according to claim 1, wherein said optical system is configured and arranged such that radiation in said first part of said projection beam is substantially prevented from being incident on said second patterning region of said patterning device.

3. A lithographic apparatus according to claim 1, wherein said optical system is configured to provide said second part of said projection beam in a first substantially polarized state.

4. A lithographic apparatus according to claim 3, wherein said optical system is configured to provide said first part of said projection beam in a second substantially polarized state that is substantially different from said first polarized state.

5. A patterning device for use in a lithographic apparatus including a projection beam having first and second parts, comprising:
a first patterning region and a second patterning region;
an optical member covering the first patterning region so as to substantially prevent radiation from the second part of the projection beam from being incident upon the first patterning region.

6. A patterning device according to claim 5, wherein said patterning device comprises a second optical member covering said second patterning region so as to substantially prevent radiation from said first part of said projection beam from being incident upon said second patterning region.

7. A patterning device according to claim 5, wherein the optical member comprises a polarizing member.

8. A patterning device according to claim 6, wherein at least one of the optical members comprises a polarizing member.

9. A patterning device according to claim 5, wherein said first patterning region comprises at least one feature which is elongated in a first direction, and wherein said first optical member selectively allows radiation from said first part of said projection beam, linearly-polarized in a second direction substantially parallel to said first direction, to be incident upon said first patterning region.

10. A patterning device according to claim 5, wherein the patterning device further comprises an optical attenuator covering a region of said patterning device so as to reduce the intensity of radiation being incident upon said region.

11. A device manufacturing method comprising:
providing a projection beam of radiation comprising a first part and a second part;
using a patterning device with a first patterning region and a second patterning region, said patterning device substantially preventing radiation from said second part of said projection beam from being incident upon said first patterning region of said patterning device;
patterning the projection beam with a pattern in its cross-section using a patterning device; and
projecting the patterned beam of radiation onto a target portion of the layer of radiation-sensitive material.

12. A device manufacturing method according to claim 11, wherein said patterning device substantially prevents radiation from said first part of said projection beam from being incident upon said second patterning region of said patterning device.

13. A device manufacturing method according to claim 11, wherein said second part of said projection beam is in a first substantially polarized state.

14. A device manufacturing method according to claim 13, wherein said first part of said projection beam is in a second substantially polarized state that is substantially different from said first polarized state.

15. A device manufacturing method according to claim 11, wherein the patterning device further comprises an optical attenuator covering a region of said patterning device so as to substantially reduce the intensity of radiation being incident upon said region.

16. A lithographic apparatus comprising:
a support structure for supporting a patterning device, the patterning device serving to pattern a projection beam according to a desired pattern;
a substrate table for holding a substrate; and
a projection system for projecting the patterned beam onto a target portion of the substrate,
wherein said patterning device comprises an optical attenuator covering a patterning region of said patterning device so as to substantially reduce the intensity of radiation being incident upon said patterning region.
